(19) United States
(12) Patent Application Publication
(10) Pub. No.: US 2021/0208869 A1
(43) Pub. Date: Jul. 8, 2021

(54) SYSTEM AND METHOD TO PROVIDE SMM RUNTIME TELEMETRY SUPPORT

(71) Applicant: Intel Corporation, Santa Clara, CA (US)

(72) Inventors: Murugasamy K. NACHIMUTHU, Beaverton, OR (US); Ruixia LI, Shanghai (CN); Siyuan FU, Shanghai (CN); Jiewen YAO, Shanghai (CN); Wei XU, Shanghai (CN)

(21) Appl. No.: 17/210,240

(22) Filed: Mar. 23, 2021

(51) Int. Cl. G06F 8/656; G06F 9/445; G06F 13/16

(52) U.S. Cl. CPC G06F 8/656; G06F 13/1673; G06F 9/445

(57) ABSTRACT

System, method, and instructions for providing system management mode (SMM) runtime telemetry support. An SMM Telemetry Service component is responsible for collecting telemetry information from other SMM components, as well as exposing the information to non-firmware component on request. The SMM Telemetry Service collects telemetry information produced by an SMM Runtime Update handler and other SMM drivers and exposes the telemetry information at runtime to an upper layer OS consumer or management unit (e.g., BMC, CSME, etc.). Since the SMM Telemetry Service is a standalone module and independent of other SMM service(s), the service is available even during a runtime SMM Driver Update. The embodiments also disclose a mechanism for managing a shared telemetry data region that can be accessed by the data producer (SMM components) and consumer (non-SMM components), without introducing additional SMI that affects system performance.

### BACKGROUND INFORMATION

System Management Mode (SMM) is one of the most important runtime components of platform firmware. SMM is responsible for managing various platform configurations and events, such as SMM protected register access, runtime BIOS NVRAM access, OSPM ACPI (Operating System directed configuration and Power Management Advance Configuration and Power Interface) assistance, Reliability, Availability and Serviceability (RAS) event handling, etc.

During the lifecycle of the platform, SMM firmware may need to be updated to address critical security vulnerabilities, power or performance related issues, SMM runtime service bug fixes or introducing additional services. This is typically achieved by a system firmware flash update, or a runtime update such as seamless SMM firmware update. It is necessary to provide enough telemetry information to users like datacenter administrator orchestrates, so they can ensure that the existing SMM firmware services are operating as expected or updated SMM firmware is operating as expected, and more important, if it is not, to provide sufficient technical details to know the current SMM information or the SMM runtime update status, and to track what might be the problem.

Today, the SMM telemetry information is not exposed, or not in a timely manner, for several reasons. First, in SMM mode, the processor runs in a separate operating environment where context is hidden from the operating system (OS), so it is difficult to have a direct approach to detect the SMM execution status. Today, the firmware telemetry information is collected during the system boot phase and then reported to non-firmware components (OS, or management unit like Baseboard Management Controller (BMC) and Management Engine (ME)). However, SMM components keep executing during OS runtime, and may also be updated and reinitialized during OS runtime. Thus, the SMM telemetry information collected at boot phase may not reflect a real-time status of SMM firmware on the platform. In addition, some SMM components provide System Management Interrupt (SMI) handlers to expose its runtime context to the non-SMM environment. On receipt an SMI, all the CPU (Central Processing Unit) threads in the system enter SMM mode immediately, which leads to unpredictable performance degradation.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram illustrating a system architecture of an SMM Telemetry Service, according to one embodiment.

FIG. 2 is a diagram of a circular buffer data structure implemented as a telemetry buffer, according to one embodiment;

FIG. 3 is a diagram of a linear buffer of telemetry buffer size (Maximum Data Chunk Size) that is reserved by BIOS;

FIGS. 4a and 4b show respective portions of a flowchart illustrating operations and logic implemented to added new log data to a circular telemetry buffer;

FIG. 5 is a flowchart illustrating the data the BIOS-OS (or BIOS-BMC) interface provides to a consumer for retrieving telemetry log data, according to one embodiment;

FIG. 6 is a flowchart illustrating operations and logic implemented by an OS or BMC agent to retrieve and parse telemetry log data, according to one embodiment; and

FIG. 7 is a diagram of a computing system that may be implemented with aspects of the embodiments described and illustrated herein.

### DETAILED DESCRIPTION

Embodiments of a system, method and instructions for providing SMM runtime telemetry support are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

In accordance with aspects of the embodiments disclosed herein, systems, methods, and associated firmware and software components are provided to collect SMM telemetry information and report it to non-firmware components at runtime, called Runtime SMM Telemetry. The embodiments introduce an SMM Telemetry Service component into SMM, which is responsible for collecting telemetry information from other SMM components, as well as exposing the information to non-firmware component on request. The SMM Telemetry Service collects telemetry information produced by an SMM Runtime Update handler and other SMM drivers and exposes the telemetry information at runtime to an upper layer OS consumer or management unit (BMC, CSME, etc.). Since the SMM Telemetry Service is a standalone module and independent of other SMM service(s), the service is available even during a runtime SMM Driver Update. The embodiments also disclose a mechanism for managing a shared telemetry data region that can be accessed by the data producer (SMM components) and consumer (non-SMM components), without introducing additional SMI that affects system performance.

The SMM Telemetry Data may contain firmware version, system log and other information of system events and operations during SMM Runtime Update or other SMM processes. One embodiment employs a human readable text log as the SMM Telemetry Data, although this is merely exemplary and non-limiting as other data formats and structures, such as encrypted data, may also be used. The SMM Telemetry Service may add additional information such as timestamp to the messages, or format messages such as using a key/value store, to make the data more readable and maintainable to the consumer.

In one embodiment, the SMM Telemetry Data is stored in a shared memory region called a Telemetry Buffer, which is a BIOS/firmware reserved region and managed by an SMM Telemetry Service component. Multiple SMM Telemetry Buffer regions may be used to keep track of different types of information or to provide data for different consumers for each specific access interface.

The SMM Telemetry Service provides an SMM telemetry protocol interface for other SMM modules to generate the telemetry data, and an external interface (e.g., OS, management unit) for accessing the telemetry data. Examples of OS interfaces include but are not limited to an ACPI method, Platform Runtime Mechanism (PRM) method or UEFI (Unified Extensible Firmware Interface) runtime service. The management unit interface may employ a DMA memory region or a dedicate MMIO (Memory-Mapped Input/Output) region, which is available to a management unit such as a BMC or CSME.

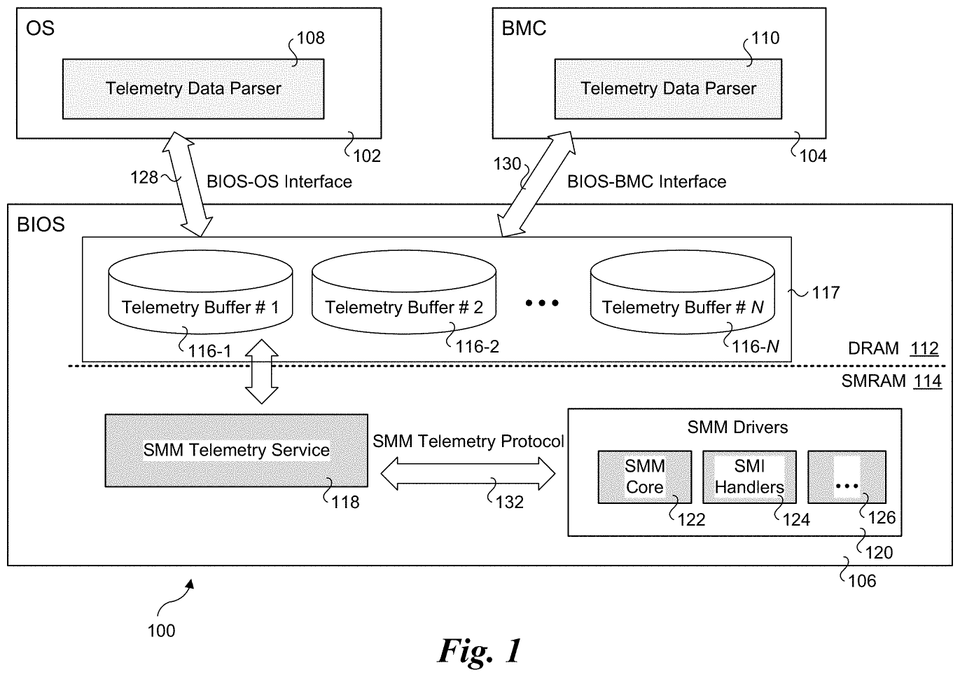

FIG. 1 shows a system architecture 100 of an SMM Telemetry Service, according to one embodiment. The top-level components of system architecture 100 include an OS 102, a BMC 104, and BIOS 106. OS 102 and BMC 104 respectively include a telemetry data parser 108 and 110. The components for BIOS 106 are split between portions of system memory comprising DRAM 112 and System Management RAM (SMRAM) 114, which is a portion of system memory that is reserved/allocated for SMM components. N telemetry buffers 116-1, 116-2, . . . 116-N are deployed in a shared telemetry buffer region 117 in DRAM 112. Since shared telemetry buffer region 117 is shared, telemetry buffers 116-1, 116-2, . . . 116-N are referred to (and comprise) shared telemetry buffers. The components in SMRAM 114 includes SMM telemetry service 118 and SMM drivers 120 including an SMM core 122, SMI handlers 124 and other SMM components 126.

Communications between OS 102 and BIOS 106 are facilitated via a BIOS-OS interface 128. Communications between BMC 104 and BIOS 106 are facilitated via a BIOS-BMC interface 130. SMM telemetry service 118 communicates and interacts with SMM drivers 120 using an SMM telemetry protocol 132.

BIOS-OS interface 128 and BIOS-BMC interface 130 are responsible for providing information for consumers to retrieve log data from telemetry buffers 116-1, 116-2, . . . 116-N. In one embodiment the following two methods of managing the telemetry data, with or without extra SMI, are supported. In one embodiment, both methods employ the same interface definition:
Method 1: Under this method, SMM telemetry service 118 is configured to maintain its own region in SMRAM 114 for new generated telemetry data, then copy it to one or more shared telemetry buffers when BIOS-OS interface 128 or BIOS-BMC interface 130 is called. This method utilizes one or more SMIs.
Method 2: Under this method, SMM Telemetry Service is configured to add new data to shared telemetry buffer region 117 directly. When BIOS-OS interface 128 or BIOS-BMC interface 130 is called, it points to the telemetry buffer region. This method does not utilize an SMI.

Method 1 requires additional SMI to get data, but it provides the advantage that the telemetry data cannot be corrupted by malicious code running in ring0, since the telemetry data is maintained inside SMRAM 114, which is hidden from OS 102. Method 2 does not need extra SMI for getting data, so it can avoid system performance degradation. An algorithm to for implementing Method 2 is described below.

Telemetry Data Management Algorithm

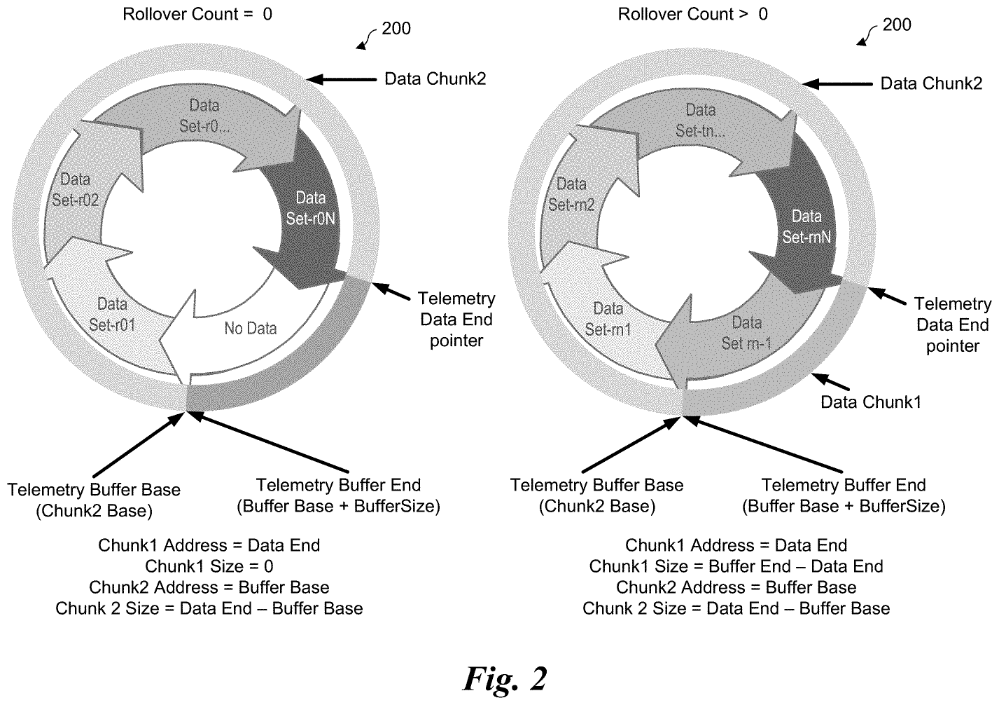

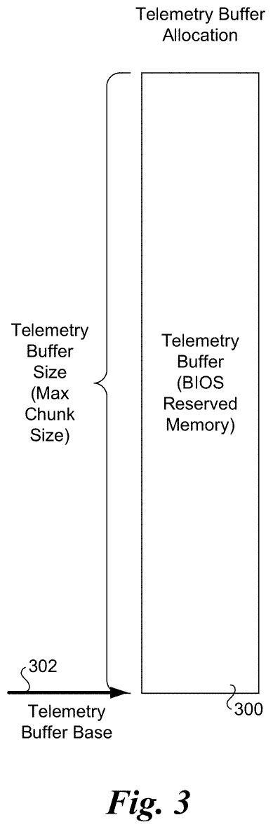

As shown in FIG. 2, an SMM Telemetry Service maintains a circular buffer data structure as the telemetry buffer 200. As shown in FIG. 3, A linear buffer 300 of telemetry buffer size (Maximum Data Chunk Size) is reserved by BIOS for this. When log data is produced, it is added from the base of the telemetry buffer and when it reaches the end of the buffer, the log data is added from the start of the buffer again and a rollover count is incremented.

In one embodiment, the SMM Telemetry Service maintains the flowing parameters and data for the circular buffer structure:
TelemetryBufferBase: Points to the start of the telemetry buffer.
TelemetryBufferSize: Size of the telemetry buffer. This is also the maximum size of a Data Chunk.
TelemetryBufferEnd: Points to the end of the telemetry buffer. This should equal TelemetryBufferBase+TelemetryBufferSize.
TelemetryDataEnd: Points to the end of current log data position.
RolloverCount: Initial value is zero and increased by 1 when log data reaches the end of telemetry buffer.
Data Chunk1: The data from TelemetryBufferBase to TelemetryDataEnd position.
Data Chunk2: Empty if rollover count is zero; The data from TelemetryDataEnd position to TelemetryBufferEnd.

When the SMM Telemetry Service starts to record log data, it resets TelemetryDataEnd set to TelemetryBufferBase and resets RolloverCount to 0.

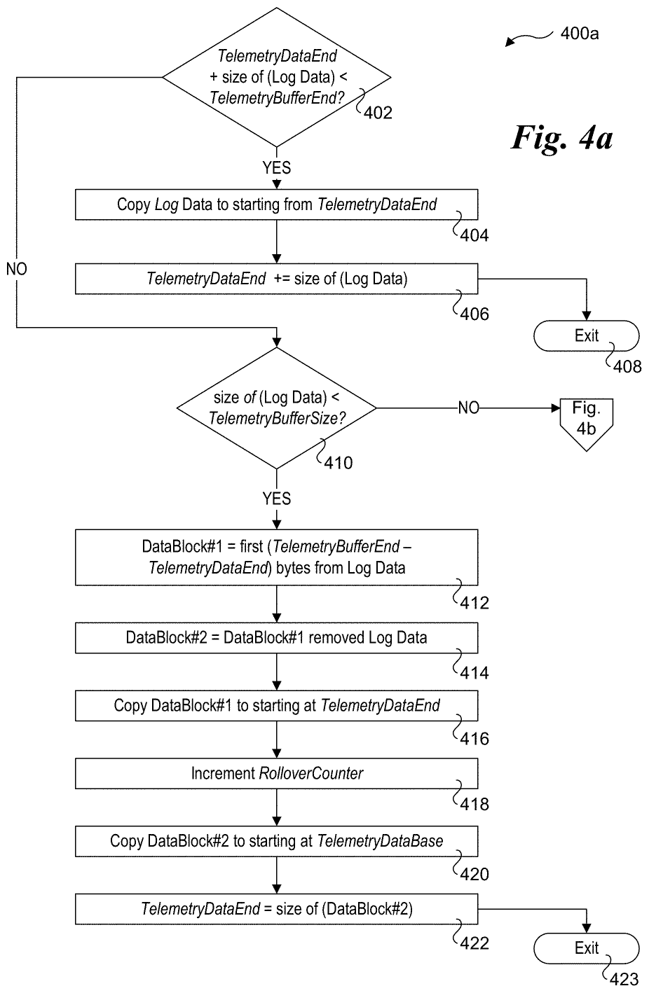

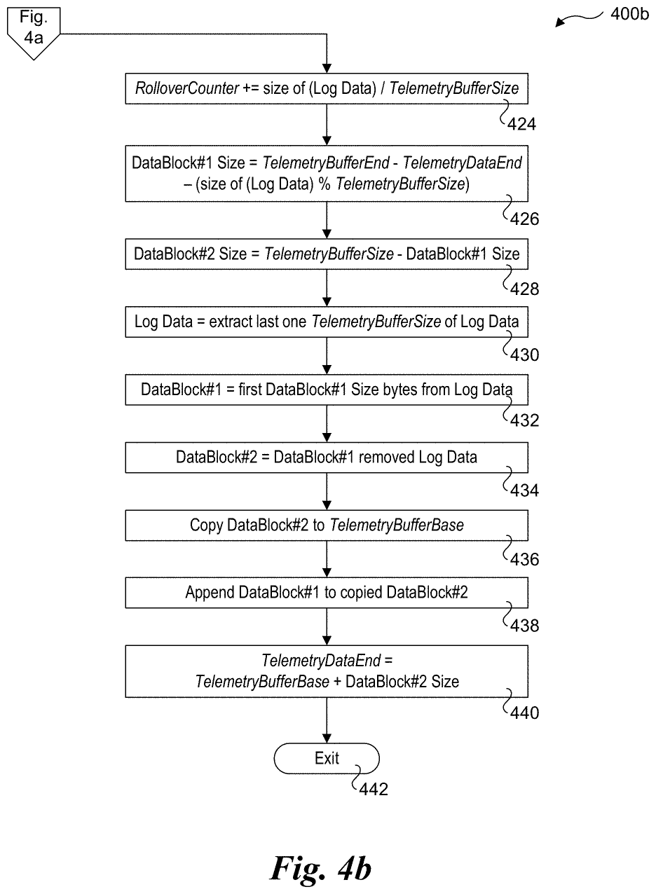

FIGS. 4a and 4b respectively show portions 400a and 400b of a flowchart illustrating operations and logic implemented to added new log data to a telemetry buffer. The logic begins with a decision block 402 wherein a determination is made to whether:

TelemetryDataEnd+size of (Log Data)<TelemetryBufferEnd

If the answer is YES, the logic proceeds to a block 404 in which the log data is copied to the telemetry buffer starting from TelemetryDataEnd. In a block 406, the size of the Log Data is added to TelemetryDataEnd to obtain a new TelemetryDataEnd value. The process then exits, as depicted by an exit block 408.

If TelemetryDataEnd+size of (Log Data)≥TelemetryBufferEnd, the answer to decision block 402 is NO, and the logic proceeds to a decision block 410 where a determined is made to whether:

size of (Log Data)<TelemetryBufferSize

If the answer is YES, to logic proceeds to a block 412 in which DataBlock #1 is added to the first (TelemetryBufferEnd−TelemetryDataEnd) bytes from the Log Data. In a block 414 DataBlock #2 is set to the size of the DataBlock #1 removed Log Data.

In a block 416 DataBlock #1 is copied to the telemetry buffer starting at TelemetryDataEnd. In a block 418 the RolloverCounter is incremented. In a block 420 DataBlock #2 is copied to the telemetry buffer starting at TelemetryDataBase. In a block 422, TelemetryDataEnd is set to size of (DataBlock #2). The process for the YES branch for decision block 410 then exits in an exist block 423.

Returning to decision block 410, if the answer is NO the logic proceeds to flowchart portion 400b in FIG. 4b. In a block 424 the RolloverCounter is incremented by the (integer of) size of (Log Data)/TelemetryBufferSize. In a block 426 Datablock #1 Size is set to TelemetryBufferEnd−TelemetryDataEnd−(size of (Log Data) % TelemetryBufferSize). In a block 428 DataBlock #2 Size is set to TelemetryBufferSize−DataBlock #1 Size.

In a block 430 the most recent Log Data obtained by extracting the last one of TelemetryBufferSize of Log Data. DataBlock #1 is then set to the first DataBlock #1 Size bytes from Log Data, as shown in a block 432, and DataBlock #2 is set to the removed Log Data for DataBlock #1, as shown in a block 434.

In a block 436, DataBlock #2 is copied to TelemetryBufferBase. In a block 438, Datablock #1 is appended to the copied DataBlock #2. In a block 440 TelemetryDataEnd is set to TelemetryBufferBase+DataBlock #2 Size. The process for flowchart portion 400b then exits, as depicted by an exit block 442.

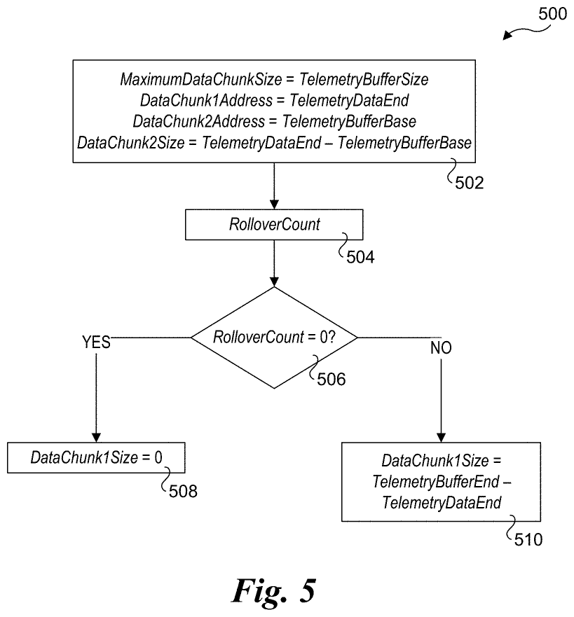

FIG. 5 shows a flowchart 500 illustrating the data the BIOS-OS (or BIOS-BMC) interface provides to a consumer for retrieving telemetry log data. As depicted in a block 502, the parameters include:
MaximumDataChunkSize=TelemetryBufferSize
DataChunk1Address=TelemetryDataEnd
DataChunk2Address=TelemetryBufferBase
DataChunk2Size=TelemetryDataEnd−TelemetryBufferBase

The current RolloverCount value is also provided, as shown in a block 504. As depicted by a decision block 506 and respective block 508 and 510, if the RolloverCount=0, the DataChunk1Size=0, otherwise,

DataChunk1Size=TelemetryBufferEnd−TelemetryDataEnd.

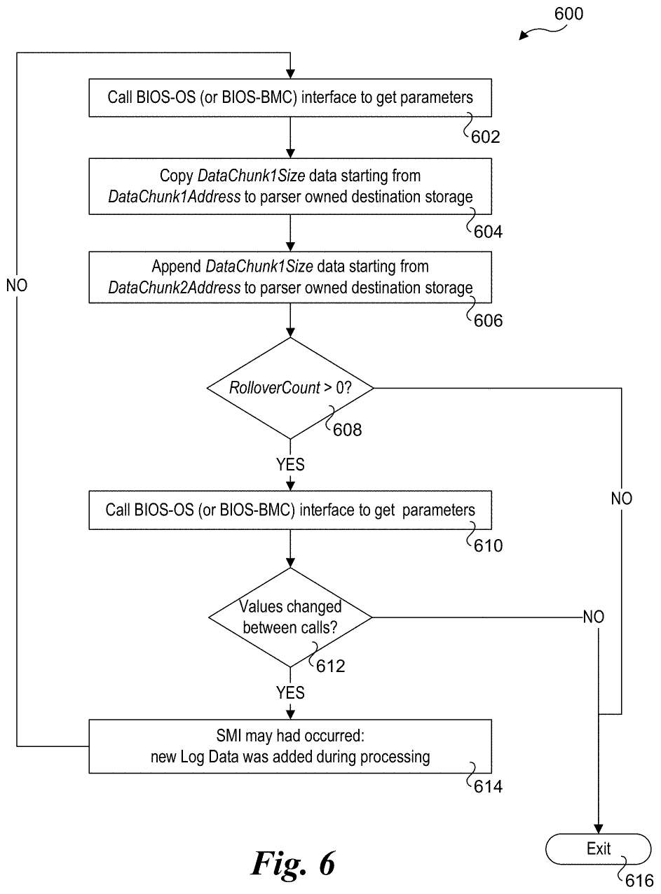

FIG. 6 shows a flowchart 600 illustrating operations and logic implemented by an OS or BMC agent to retrieve and parse the telemetry log data (e.g., using telemetry data parsers 108 and 110, respectively). The process begins in a block 602 in which the BIOS-OS (or BIOS-BMC) interface is called to get the parameters described above in FIG. 5. In a block 604 DataChunk1Size data is copied starting from the DataChunk1Address to parser owned destination storage. For telemetry data parser 108 in OS 102, the parser owned destination storage will generally be in system memory. For telemetry data parser 110 for BMC 102, the parser owned destination storage will generally be in memory on-board the BMC.

In a block 606, DataChunk1Size of data is copied for the telemetry buffer starting from DataChunk1Address to the parser owned destination storage. In a decision block 608 a determination is made to whether the RolloverCount>0. If it is not, the process exits, as depicted by an exit block 616.

When the RolloverCount>0, the logic proceeds to a block 610 in which the BIOS-OS (or BIOS-BMC) interface is called to get the parameters described above in FIG. 5. This is similar to the call made in block 602, except some parameter values may have changed via the operations performed in blocks 604 and 606.

In a decision block 612, a determination is made to whether any parameter values have changed between the calls in blocks 602 and 610. For example, the returned data between blocks 602 and 610 (e.g., DataChunk1Address, DataChunk1Size, DataChunk2Address, DataChunk2Size, RolloverCount, TelemetryServiceResetCount) are compared to detect if any changes have occurred. If the answer is NO, the process exits at exit block 616. If parameter values have changed, the answer is YES and the logic proceeds to a block 614. As shown, an SMI may had occurred (between the calls); thus, new Log Data was added during processing. Basically, if the parameters are not the same, an SMI may have occurred during the telemetry data reading by the OS/BMC and an SMI may have updated portions of the data. Hence re-reading ensures no SMI changes data during the telemetry data collection process. As depicted by the loop back to block 602, the operations in flowchart 600 are repeated until no parameter value change between calls.

### Example Platform/Server

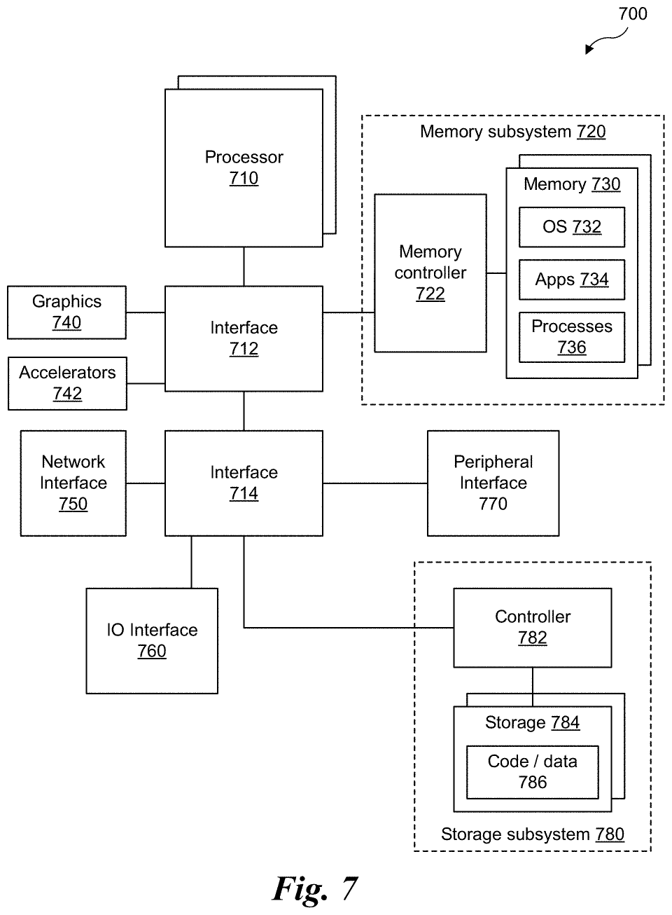

FIG. 7 depicts a compute platform 700 such as a server or similar computing system in which aspects of the embodiments disclosed above may be implemented. Compute platform 700 includes one or more processors 710, which provides processing, operation management, and execution of instructions for compute platform 700. Processor 710 can include any type of microprocessor, central processing unit (CPU), graphics processing unit (GPU), processing core, multi-core processor or other processing hardware to provide processing for compute platform 700, or a combination of processors. Processor 710 controls the overall operation of compute platform 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, compute platform 700 includes interface 712 coupled to processor 710, which can represent a higher speed interface or a high throughput interface for system components that needs higher bandwidth connections, such as memory subsystem 720 or optional graphics interface components 740, or optional accelerators 742. Interface 712 represents an interface circuit, which can be a standalone component or integrated onto a processor die. Where present, graphics interface 740 interfaces to graphics components for providing a visual display to a user of compute platform 700. In one example, graphics interface 740 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 740 generates a display based on data stored in memory 730 or based on operations executed by processor 710 or both. In one example, graphics interface 740 generates a display based on data stored in memory 730 or based on operations executed by processor 710 or both.

Memory subsystem 720 represents the main memory of compute platform 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in compute platform 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for compute platform 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

While not specifically illustrated, it will be understood that compute platform 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect Express (PCIe) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, computing platform 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides computing platform 700 the ability to communicate with remote devices (e.g., servers or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory. Network interface 750 can receive data from a remote device, which can include storing received data into memory. Various embodiments can be used in connection with network interface 750, processor 710, and memory subsystem 720.

In one example, computing platform 700 includes one or more IO interface(s) 760. IO interface 760 can include one or more interface components through which a user interacts with computing platform 700 (e.g., audio, alphanumeric, tactile/touch, or other interfacing). Peripheral interface 770 can include any hardware interface not specifically mentioned above. Peripherals refer generally to devices that connect dependently to computing platform 700. A dependent connection is one where computing platform 700 provides the software platform or hardware platform or both on which operation executes, and with which a user interacts.

In one example, computing system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination.

In an example, compute platform 700 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), quick UDP Internet Connections (QUIC), RDMA over Converged Ethernet (RoCE), Peripheral Component Interconnect express (PCIe), Intel® QuickPath Interconnect (QPI), Intel® Ultra Path Interconnect (UPI), Intel® On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof. Data can be copied or stored to virtualized storage nodes using a protocol such as NVMe over Fabrics (NVMe-oF) or NVMe.

In addition to applying secure execution mode firmware for computing platforms with processor or CPUs, the teaching and principles disclosed herein may be applied to Other Processing Units (collectively termed XPUs) including one or more of Graphic Processor Units (GPUs) or General Purpose GPUs (GP-GPUs), Tensor Processing Unit (TPU) Data Processor Units (DPUs), Infrastructure Processing Units (IPUs), Artificial Intelligence (AI) processors or AI inference units and/or other accelerators, FPGAs and/or other programmable logic (used for compute purposes), etc. While some of the diagrams herein show the use of processors, this is merely exemplary and non-limiting. Generally, any type of XPU may be used in place of a CPU or processor in the illustrated embodiments. Moreover, as used in the following claims, the term “processor” is used to generically cover various forms of processors including CPUs and different forms of XPUs.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Italicized letters, such as ‘N’ in the foregoing detailed description are used to depict an integer number, and the use of a particular letter is not limited to particular embodiments. Moreover, the same letter may be used in separate claims to represent separate integer numbers, or different letters may be used. In addition, use of a particular letter in the detailed description may or may not match the letter used in a claim that pertains to the same subject matter in the detailed description.

As discussed above, various aspects of the embodiments herein may be facilitated by corresponding software and/or firmware components and applications, such as software and/or firmware executed by an embedded processor or the like. Thus, embodiments of this invention may be used as or to support a software program, software modules, firmware, and/or distributed software executed upon some form of processor, processing core or embedded logic a virtual machine running on a processor or core or otherwise implemented or realized upon or within a non-transitory computer-readable or machine-readable storage medium. A non-transitory computer-readable or machine-readable storage medium includes any mechanism for storing or transmitting information in a form readable by a machine (e.g., a computer). For example, a non-transitory computer-readable or machine-readable storage medium includes any mechanism that provides (e.g., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A non-transitory computer-readable or machine-readable storage medium may also include a storage or database from which content can be downloaded. The non-transitory computer-readable or machine-readable storage medium may also include a device or product having content stored thereon at a time of sale or delivery. Thus, delivering a device with stored content, or offering content for download over a communication medium may be understood as providing an article of manufacture comprising a non-transitory computer-readable or machine-readable storage medium with such content described herein.

Various components referred to above as processes, servers, or tools described herein may be a means for performing the functions described. The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including non-transitory computer-readable or machine-readable storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method implemented on a compute platform including a processor coupled to system memory and configured to execute system firmware and software resident on the compute platform, the system firmware including system management mode (SMM) firmware and the software comprising software components including an operating system, the method comprising:
performing operating system runtime execution of software;
performing a runtime update of the SMM firmware; and
exposing runtime SMM telemetry information to a non-firmware component.

2. The method of claim 1, wherein the non-firmware component comprises an operating system component.

3. The method of claim 2, wherein the system firmware comprises BIOS, further comprising implementing a telemetry data parser as an operating system component, wherein the telemetry data parser is configured to access SMM telemetry information from one or more telemetry buffers implemented in system memory via a BIOS-OS interface.

4. The method of claim 1, wherein the compute platform includes a management component and wherein the non-firmware component comprises the management component.

5. The method of claim 4, wherein the system firmware comprises BIOS, further comprising implementing a telemetry data parser in the management component, wherein the telemetry data parser is configured to access SMM telemetry information from one or more telemetry buffers implemented in system memory via a BIOS-management component interface.

6. The method of claim 1, wherein the SMM firmware includes SMM drivers, further comprising:
allocating a portion of the system memory to system management random access memory (SMRAM);
loading the SMM drivers into SMRAM;
implementing an SMM telemetry service in SMRAM; and
employing the SMM telemetry service to collect SMM telemetry information from one or more SMM drivers.

7. The method of claim 6, further comprising:
writing SMM telemetry information that is collected to one or more telemetry buffers implement in a portion of system memory.

8. The method of claim 7, wherein the system firmware comprises BIOS, and wherein the portion of system memory the one or more telemetry buffers are implemented in comprises a portion of system memory external to SMRAM, further comprising:
writing SMM telemetry information to the one or more telemetry buffers; and
calling a BIOS interface to access data from at least one of the one or more telemetry buffers.

9. The method of claim 1, further comprising:
collecting SMM telemetry information from SMM components on the compute platform;
logging SMM telemetry information that is collected in one or more circular buffers;
implementing a buffer rollover mechanism to enable a chunk of logged data written to an end of a circular buffer and to a start of the circular buffer to be accessed from the circular buffer.

10. A compute platform, comprising:
a processor;
system memory, operatively coupled to the processor;
a firmware storage device in which firmware instructions comprising a plurality of firmware components including system management mode (SMM) firmware are stored; and
software components, residing in system memory or stored in a storage device operatively coupled to the processor, including an operating system (OS),
wherein, execution of the firmware and software components enable the compute platform to:
perform operating system runtime execution of software;
perform a runtime update of the SMM firmware; and
expose runtime SMM telemetry information to a non-firmware component on the compute platform.

11. The compute platform of claim 10, wherein the non-firmware component comprises an operating system component, and wherein the system firmware comprises BIOS, wherein the software components include a telemetry data parser, wherein execution of the firmware and software components further enable the compute platform to access SMM telemetry information from one or more telemetry buffers implemented in system memory and parse the SMM telemetry information with the telemetry data parser.

12. The compute platform of claim 10, wherein the compute platform includes a management component and wherein the non-firmware component comprises the management component.

13. The compute platform of claim 12, wherein the firmware components include BIOS, wherein a telemetry data parser is implemented in the management component, and wherein the telemetry data parser is configured to access SMM telemetry information from one or more telemetry buffers implemented in system memory via a BIOS-management component interface.

14. The compute platform of claim 10, wherein the SMM firmware includes SMM drivers, and wherein execution of the firmware and software components further enable the system to:
allocate a portion of the system memory to system management random access memory (SMRAM);
load the SMM drivers into SMRAM;
implement an SMM telemetry service in SMRAM; and
employ the SMM telemetry service to collect SMM telemetry information from one or more SMM drivers.

15. The compute platform of claim 14, wherein the system firmware comprises BIOS, and wherein one or more telemetry buffers are implemented in a portion of system memory external to SMRAM, and wherein execution of the firmware and software components further enable the system to:
write SMM telemetry information to the one or more telemetry buffers; and
call a BIOS interface to access data from at least one of the one or more telemetry buffers.

16. The compute platform of claim 14, wherein execution of the firmware and software components further enable the system to:
collect SMM telemetry information from SMM components on the compute platform;
log SMM telemetry information that is collected in one or more circular buffers in system memory; and
implement a buffer rollover mechanism to enable a chunk of logged data written to an end of a circular buffer and to a start of the circular buffer to be accessed from the circular buffer.

17. A non-transitory machine-readable storage medium having instructions comprising firmware components stored thereon configured to be executed on processor of compute platform including system memory coupled to the processor, the firmware components including system management mode (SMM) firmware components and an SMM telemetry service, wherein execution of the instructions enables the compute platform to:
employ the SMM telemetry service to collect SMM telemetry information from one or more SMM components; and
log collected telemetry data to one or more telemetry buffers in the system memory.

18. The non-transitory machine-readable storage medium of claim 17, wherein the SMM firmware components include SMM drivers, and wherein execution of the instructions further enable the system to:
allocate a portion of the system memory to system management random access memory (SMRAM);
load the SMM drivers into SMRAM;
implement the SMM telemetry service in SMRAM; and
employ the SMM telemetry service to collect SMM telemetry information from one or more SMM drivers.

19. The non-transitory machine-readable storage medium of claim 17, wherein execution of the instructions further enable the system to:
perform a runtime update of SMM firmware components; and
collect SMM telemetry information from one or more SMM components that are updated.

20. The non-transitory machine-readable storage medium of claim 17, wherein execution of the instructions further enable the system to:
log collected telemetry information in one or more circular buffers in system memory; and
implement a buffer rollover mechanism to enable a chunk of logged data written to an end of a circular buffer and to a start of the circular buffer to be accessed from the circular buffer.
